(19) United States
(12) Patent Application Publication
(10) Pub. No.: US 2004/0057368 A1
(43) Pub. Date: Mar. 25, 2004

(54) Optical storage apparatus and housing

(76) Inventor: Song-Ling Chang, Taipei (TW)

Correspondence Address: Cynthia L. Pillote, Snell & Wilmer L.L.P., One Arizona Center, 400 East Van Buren, Phoenix, AZ, 85004-2202, US

(21) Appl. No.: 10/639,065

(22) Filed: Aug. 12, 2003

(30) Foreign Application Priority Data
Sep. 19, 2002 (TW) 91214786

(51) Int. Cl. G11B 33/02

(52) U.S. Cl. 369/75.1

(57) ABSTRACT

The present invention discloses an optical storage apparatus using a housing with a heat dissipation structure. The housing includes a cover, a panel and a base. The cover has a hole for the panel to be selectively inserted within. The panel includes a protrusion to provide a gap between the panel and the cover as the panel is inserted within the hole. The gap is for an air flow generated by the optical storage apparatus to pass through. The present invention further includes an opening and a guiding plate. The opening communicates with the gap. The guiding plate is set besides the opening. The guiding plate is provided to guide the air flow through the gap so that heat generated by the optical storage apparatus is dissipated.

### CROSS REFERENCE TO RELATED APPLICATIONS

This application claims priority of Taiwan Patent Application Serial No. 091214786 filed on Sep. 19, 2002.

### FIELD OF INVENTION

The present invention relates to an optical storage apparatus using a housing with a heat dissipation structure.

### BACKGROUND OF THE INVENTION

As the rotation speed of present optical storage apparatus is developed to be higher and higher, more and more heat is produced during operation. The optical storage apparatus may have a shorter lifespan or a breakdown if the heat is not effectively dissipated. Accordingly, heat dissipation has been an important issue for optical storage apparatus design.

Conventionally, heat dissipation may be achieved by disposing a fan on and/or a hole through the cover of the optical storage apparatus. However, small fans have limited effect, and large fans are not suitable for external optical storage apparatus. Therefore, more or larger holes may be the resolution of heat dissipation.

Nevertheless, there are more issues over designing an external optical storage apparatus than designing a built-in apparatus. For example, dust may enter the external optical storage apparatus through the holes and cause breakdown. Hence a heat dissipation structure designed for the external optical storage apparatus is needed to effectively dissipate heat and prevent dust from entering.

### SUMMARY OF THE INVENTION

One aspect of the present invention provides an optical storage apparatus using a housing with a heat dissipation structure, which dissipates heat more effectively.

A housing of an external optical storage apparatus is disclosed. The housing includes a base, a cover and a panel. The cover has a hole for the panel to be selectively inserted within. There is a gap between the panel and the cover. The panel includes an opening communicating with the gap.

The emission of the optical pick-up head, the running of the motor and the operation of the electronic devices all generate heat. The rotation of a disk drives the air to produce an air flow. The air flow may go out of the housing through the opening and the gap, so that the heat dissipation efficiency is improved.

In addition, the panel further includes a guiding plate fixed on one side of the opening. The guiding plate is for guiding the air flow through the opening and out of the housing, to enhance dissipation.

The advantages and spirit of the present invention may be further comprehended through the following detailed description and drawings.

### BRIEF DESCRIPTION OF THE DRAWINGS

FIG. 1 is a schematic diagram of a housing according to a first exemplary embodiment of the present invention;

FIG. 2(A) is an inside view of a cover and a panel according to the first exemplary embodiment;

FIG. 2(B) is an explosive view of the cover and the panel according to the first exemplary embodiment;

FIG. 3 is a schematic diagram of the front of the panel according to the first exemplary embodiment;

FIG. 4 is a cross-sectional diagram along the line I-I′ in FIG. 2(A);

FIG. 5 is a schematic diagram of a housing according to a second exemplary embodiment of the present invention;

FIG. 6(A) is an inside view of a cover and a panel according to the second exemplary embodiment;

FIG. 6(B) is an explosive view of the cover and the panel according to the second exemplary embodiment;

FIG. 7 is a schematic diagram of the front of the panel according to the second exemplary embodiment; and

FIG. 8 is a cross-sectional diagram along the line II-II′ in FIG. 6(A).

### DETAILED DESCRIPTION

The present invention discloses an optical storage apparatus using a housing with a heat dissipation structure, which dissipates heat more effectively.

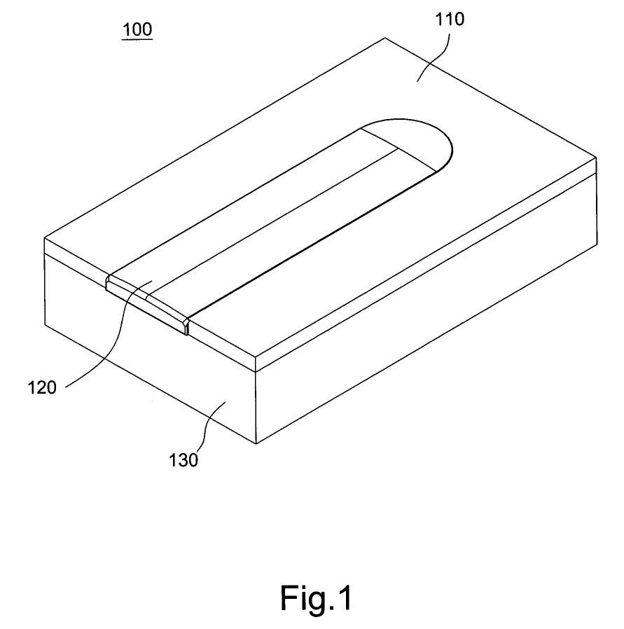

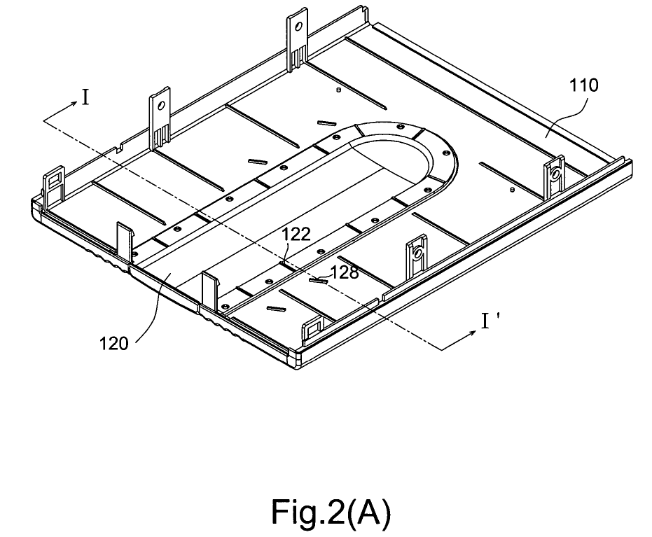

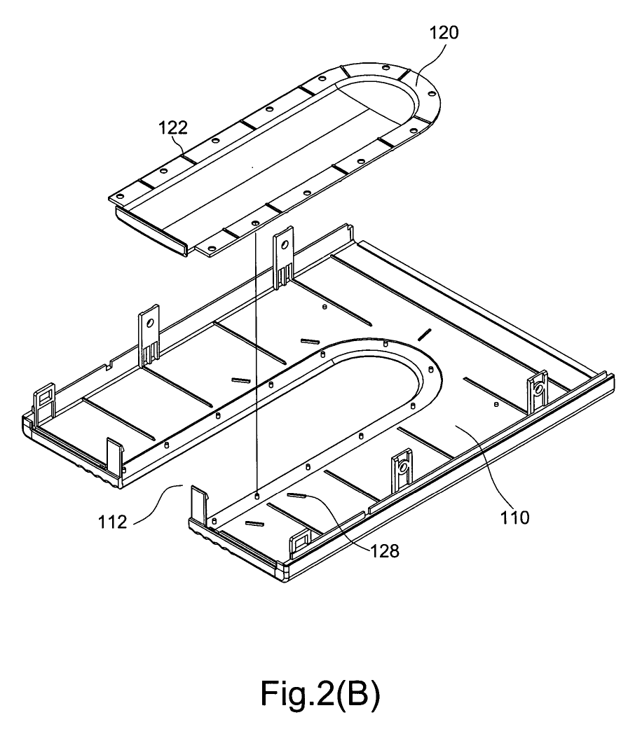

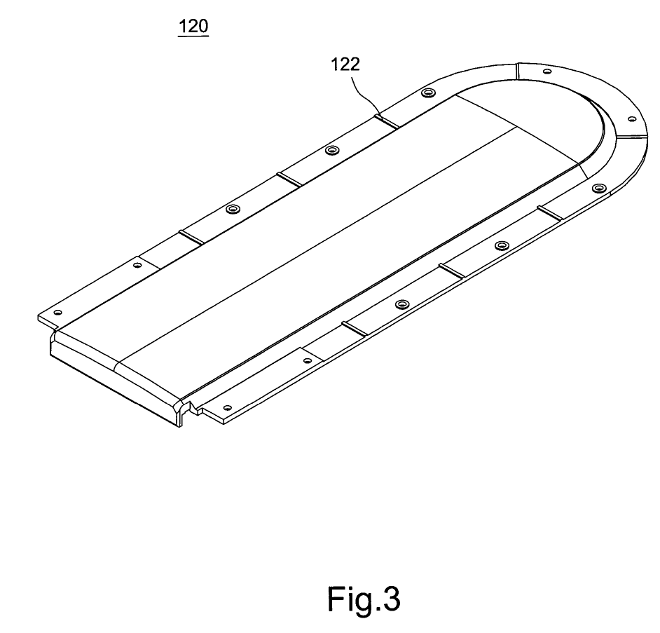

FIG. 1 is a schematic diagram of a housing 100 according to a first exemplary embodiment. The housing 100 includes a cover 110, a panel 120 and a base 130. FIGS. 2(A) and 2(B) are the inside view and the explosive view of the cover 110 and the panel 120 according to the first exemplary embodiment. The cover 110 has a hole 112 for the panel 120 to be selectively inserted within. A protrusion 122 provides a gap between the panel 120 and the cover 110 when the panel 120 is inserted within the hole 112. The protrusion 122 may be provided on the panel 120 or the cover 110. In this exemplary embodiment, as shown in FIG. 3, a number of protrusions 122 are provided on the panel 120.

To improve the heat dissipation, the housing 100 further includes a guiding plate 128 fixed on one side of the gap. As shown in FIGS. 2(A) and 2(B), the guiding plate 128 is disposed on the lower surface of the cover 110. The shape of guiding plate 128 matches the direction of air flow 40 to guide the air flow 40 through the gap and out of the housing 100, to enhance dissipation.

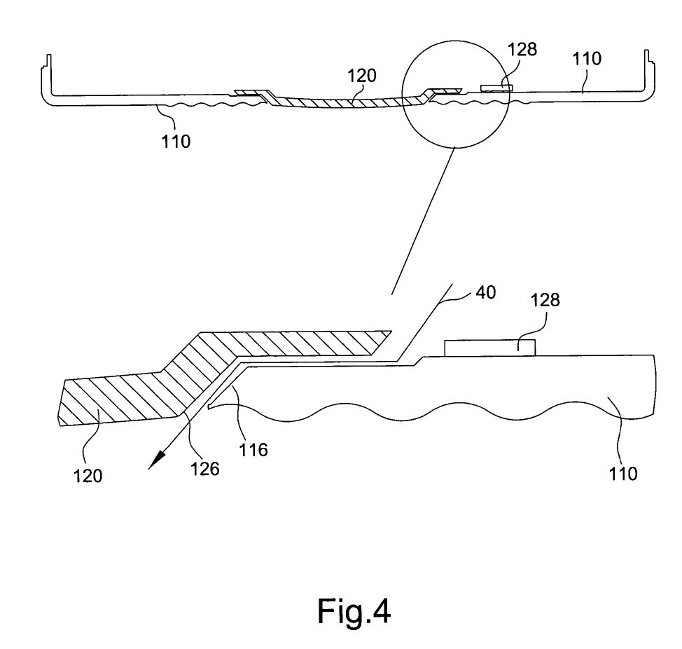

FIG. 4 is a cross-sectional diagram along the line I-I′ in FIG. 2(A). The operation of the optical storage apparatus gives out heat. The rotation of disk drives the air to produce an air flow 40. The air flow 40 may go out of the housing 100 through the gap so that the heat dissipation efficiency is improved.

Besides, to prevent dust from entering the optical storage apparatus through the gap, the edge of hole 112 may be an incline 116, as shown in FIG. 4. Similarly, the corresponding portion of the panel 120 may also be an incline 126. Therefore, the gap is essentially located between the incline 116 and the incline 126, and the dust may be prevented from entering.

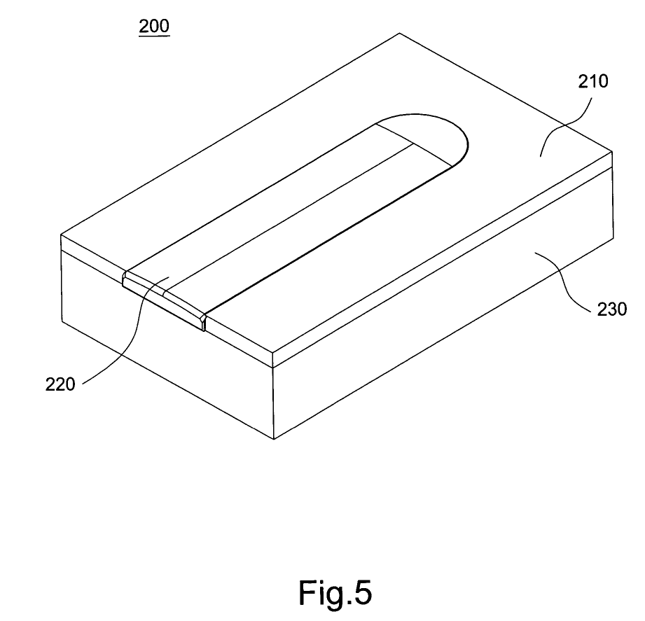

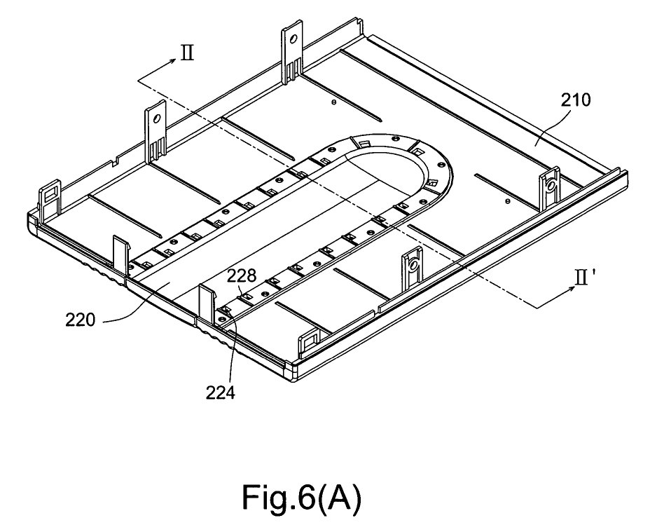

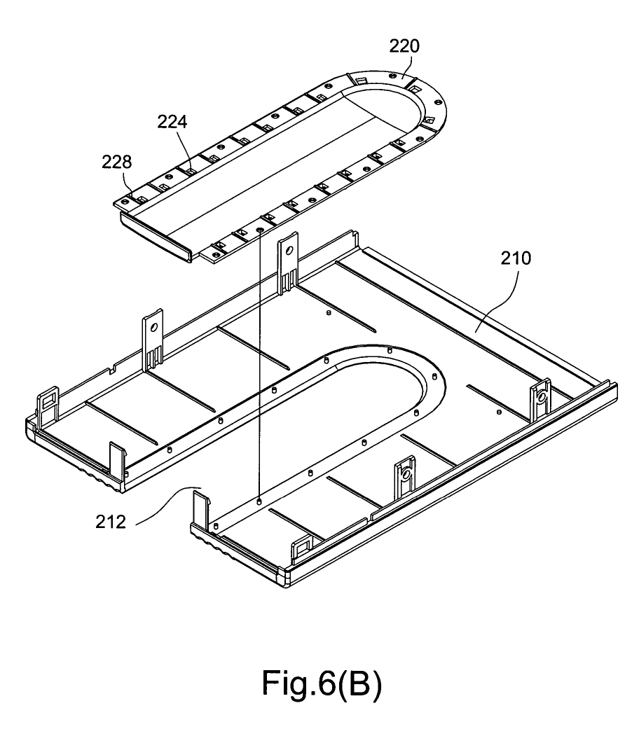

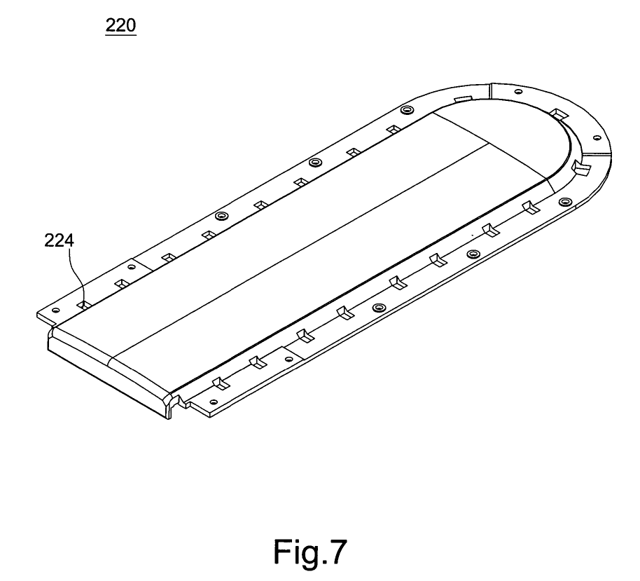

FIG. 5 is a schematic diagram of a housing 200 according to a second exemplary embodiment. The housing 200 includes a cover 210, a panel 220 and a base 230. FIGS. 6(A) and 6(B) are the inside view and the explosive view of the cover 210 and the panel 220 according to the second exemplary embodiment. The cover 210 has a hole 212 for the panel 220 to be selectively inserted within. A gap is formed at the connection of the panel 220 and the cover 210 when the panel 220 is inserted within the hole 212. The panel 220 includes an opening 224. The opening 224 communicates with the gap and allows the air flow to pass. In this exemplary embodiment, as shown in FIG. 7, a number of openings 224 are disposed on the panel 220 to allow the air flow to pass and the heat to be dissipated.

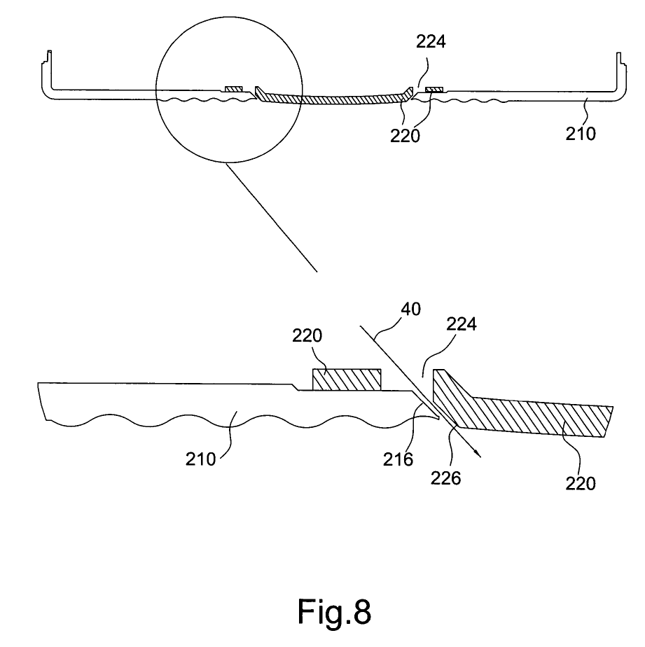

FIG. 8 is a cross-sectional diagram along the line II-II′ in FIG. 6(A). The air flow 40 resulting from operation of the optical storage apparatus goes out of the housing 200 through the opening 224 and the gap. To improve heat dissipation, the panel 220 further includes a guiding plate 228 fixed on one side of the opening 224 to guide the air flow 40 through the opening 224. As shown in FIGS. 6(A) and 6(B), the guiding plates 228 are disposed beside each of a number of openings 224 to guide the air flow 40.

Besides, to enhance the appearance and to prevent dust from entering the optical storage apparatus through the gap, the edge of hole 212 may be an incline 216. Similarly, the corresponding portion of the panel 220 may also be an incline 226. Therefore, the optical storage apparatus may not be seen through, and the dust may be prevented from entering.

While this invention has been described with reference to the illustrative embodiments, these descriptions should not be construed in a limiting sense. Various modifications of the illustrative embodiment, as well as other embodiments of the invention, will be apparent upon reference to these descriptions. It is therefore contemplated that the appended claims will cover any such modifications or embodiments as falling within the true scope of the invention and its legal equivalents.

I claim:

1. An optical storage apparatus, said optical storage apparatus having a housing, said optical storage apparatus comprising:
a base;
a cover disposed on said base, said cover having a hole;
a panel being selectively inserted within said hole; and
a protrusion for providing a gap between said panel and said cover as the panel is inserted within said hole.

2. The optical storage apparatus of claim 1, wherein an air flow resulting from operation of said optical storage apparatus flows out of said housing through said gap.

3. The optical storage apparatus of claim 2, wherein said cover further comprises a guiding plate for guiding said air flow through said gap.

4. The optical storage apparatus of claim 1, wherein said protrusion is provided on said panel.

5. The optical storage apparatus of claim 1, wherein said protrusion is provided on said cover.

6. The optical storage apparatus of claim 1, wherein said optical storage apparatus is an external optical storage apparatus.

7. An optical storage apparatus, said optical storage apparatus having a housing, said optical storage apparatus comprising:
a base;
a cover disposed on said base, said cover having a hole; and
a panel being selectively inserted within said hole, wherein a gap is formed at the connection of said panel and said cover, said panel comprises at least one opening, said opening communicates with said gap.

8. The optical storage apparatus of claim 7, wherein an air flow resulting from operation of said optical storage apparatus flows out of said housing through said opening and said gap.

9. The optical storage apparatus of claim 8, wherein said panel further comprises at least one guiding plate for guiding said air flow through said opening.

10. The optical storage apparatus of claim 7, wherein said optical storage apparatus is an external optical storage apparatus.

11. The optical storage apparatus of claim 1, wherein said cover comprises an inclined surface adjacent said hole.

12. The optical storage apparatus of claim 7, said cover further comprising an inclined surface, wherein an air flow resulting from operation of said optical apparatus flows out of said housing proximate said inclined surface.
